(19) United States
(12) Patent Application Publication
(10) Pub. No.: US 2001/0044743 A1
(43) Pub. Date: Nov. 22, 2001

(54) System and method for profile driven commerce

(76) Inventors: James M. McKinley, Austin, TX (US); Jeffery P. Hoogendam, Austin, TX (US)

Correspondence Address: TAYLOR RUSSELL & RUSSELL, PC, 4807 SPICEWOOD SPRINGS ROAD, BUILDING ONE, SUITE 1200, AUSTIN, TX, 78745

(21) Appl. No.: 09/794,786

(22) Filed: Feb. 27, 2001

Related U.S. Application Data
(60) Provisional application No. 60/192,990, filed on Mar. 28, 2000.

(51) Int. Cl. G06F 17/60

(52) U.S. Cl. 705/14; 705/26; 705/10

(57) ABSTRACT

A system and method are disclosed for profile driven commerce that relate generally to assisting consumers in the purchase of goods and services. The invention concerns comparing a profile and lifestyle of related consumer activity to specific offerings from providers of goods and services to obtain the most benefit-effective match of user profile and lifestyle to provider market offerings. The disclosed profile driven commerce system receives consumer goods and service usage profile and lifestyle information, stores the information, calculates consumer benefits for each of a plurality of market offerings using the profile and lifestyle information, determines a predetermined number of market offerings having highest values of calculated consumer benefits, and displays the predetermined number of highest benefit market offerings. From the displayed list, the consumer may elect to switch to one of the plans or to receive periodic notification of higher benefit alternatives in the future.

### BACKGROUND

This application claims the benefit of U.S. Provisional Application No. 60/192,990, filed on Mar. 28, 2000.

This invention relates generally to assisting consumers in the purchase of goods and services. More particularly, the invention concerns comparing a profile of related consumer activity and lifestyle to specific market offerings from providers of goods and services to obtain the most benefit-effective match of user profile and lifestyle information to market offerings. Consumers may be any individual, group of individuals, organization or entity that consumes goods and services.

There are a number of paradigms that describe the interactions between a buyer and a seller in affecting a trading transaction for goods and services. Bartering has historically been and continues to be used in many parts of the world to arrive at an agreement to trade by exchanging one type of goods or services for another. In this paradigm, offers and counter-offers are exchanged between two parties until an agreement to trade is reached through a process of haggling.

With the industrial revolution came the mass production of goods and services. With many competing goods and services, it became necessary for suppliers of these goods and services to use means for attracting buyers to their products through various forms of marketing, merchandising and advertising. This often required the supplier to designate an advertised price for the goods and services that was relatively firm or fixed, eliminating much of the haggling that was formerly involved in exchange transactions. This resulted in a traditional paradigm where the supplier controlled the price of the goods and services that were offered for sale, leaving a potential buyer to accept the quoted price or look elsewhere for a more desirable transaction.

Auctions and the various stock and commodity exchanges form another paradigm where neither a single buyer nor seller controls the price of a product or service. In this paradigm, the buyers as a group determine the selling price that the seller may accept or reject. This provides an efficient process for matching buyers and seller where neither buyer nor seller is favored.

In the present post-industrial society, a majority of e-commerce activities have automated the traditional paradigm, where sellers set the price, terms and conditions of an offer and a buyer may choose to accept or reject the offer. There have been a limited number of buyer-driven schemes for affecting a purchase of goods and services, such as electronic bulletin boards and traditional request for proposals (RFPs). Since these schemes either have limited exposure or involve high cost items requiring a substantial buyer investment, their use has been generally limited to a relatively few items. A new buyer-driven paradigm has been implemented on the Internet that enables efficient transactions involving goods and services. Under this paradigm, buyers name their price for goods and services in order to locate and buy these items. However, under this paradigm, information that is available to the buyer before a transaction is consummated is limited. Many consumers are uncomfortable committing to a purchase with little information about the goods or services they are buying.

Consumers often face a difficult task in selecting and managing the purchase of goods and services. The market for basic recurring purchases of goods and services includes, for example, telecommunications, electricity, natural gas, and entertainment services. These markets are undergoing a tremendous amount of change as they are transformed from regulated, monopolistic, fixed price markets to those with numerous competitors. For example, the Telecom Act of 1996 transformed the industry from just a few players to over 1,200 carriers. In the long distance market, there are over 5,000 long distance plans with rates between plans varying by 500%. In Pennsylvania, consumers have a choice of 30 providers of electricity. Internet connectivity services provide choices of dial-up, xDSL, cable modem, wireless and satellite choices. Other markets are beginning to deregulate as well.

All of this change and deregulation has led to a proliferation of choices. In the past, it was relatively simple: consumers of these goods and services had no choice of market offerings such as various providers or pricing plans. Today, with deregulated markets, there are thousands of optional plans with widely varying rates. The overwhelming number of choices has left many consumers confused and uncertain as to how to compare, select and manage the purchase of these basic recurring services. Studies have shown that over 70% of long distance telephone users are not certain that they are getting the best plan for their calling habits. This confusion and uncertainty has created a dilemma for consumers: spend an inordinate amount of time gathering and analyzing information on all of the different market offerings to find which goods and services are best for their needs, or pay more than necessary for the same quality of goods and services.

Many of the recurring goods and services required by consumers are commodity products that consumers do not want to shop for on a monthly basis. Since there is little differentiation in the quality of these commodity products, many providers of these products have tailored several offerings of these products to target specific market segments, thereby providing an opportunity to differentiate the prices of their products from those offered by their competition. These markets segments are identified primarily by the product usage or lifestyle characteristics of the consumers within the targeted market segments. The result is often a plethora of complex market offerings that make it extremely difficult, if not impossible, for a consumer to make an objective side-by-side comparison in order to obtain an offering that is most suitable for a particular consumer's usage or lifestyle characteristics. An almost continual shifting of characteristics of these market offerings such prices and quality of these goods and services further compound the situation. The marketplace becomes increasingly complex and confusing as the number of competitive market offerings and options continues to rise dramatically. Consumers are further pressured to save time and money in their lives and require help to make decisions.

This environment has created a need for a new paradigm for buyer-driven commerce that creates a more efficient method for consumers of goods and services to match their consumption or lifestyle characteristics to that of one of the many market offerings by suppliers of these recurring goods and services to achieve a benefit-effective match. Therefore, it is one object of the current invention to provide a profile driven commerce (PDC) paradigm that matches the buying requirements or lifestyle profile of consumers to an offering by a product or service supplier to solve the problems of confusion and over-paying.

Another object of the present invention is to enable a consumer of goods and services to compare prequalified offers that match the consumer's profile or lifestyle, which the consumer can accept or reject.

Yet another object of the present invention is to remember the buying requirements or lifestyle of a consumer, to track the consumer's usage and market rates, updating these requirements as necessary, to periodically verify the match of the consumer buying profile or lifestyle to market offerings, and to present the results to the consumer for acceptance or rejection.

A further object of the present invention is to provide suppliers of goods and services with aggregate profile or lifestyle information from selected classes of consumers in order to provide better goods and services to these groups.

A further object of the invention is to provide a seamless switching and provisioning process to suppliers of goods and services.

### SUMMARY OF THE INVENTION

Profile driven commerce (PDC) captures the buying requirements or lifestyle a consumer and creates a customized user profile. PDC then shops hundreds of market offerings of that product or service, and locates the best matches of goods and services offered to the specific user profile and lifestyle. Once the best matches have been found, PDC delivers the results back to the consumer in the form of customized, prequalified offers that the consumer can accept or reject. Furthermore, PDC remembers the user profile or lifestyle (and updates it as needed), continually shops on behalf of the consumer, and sends the consumer customized offers when better matches become available.

There are many benefits of PDC for the consumer. PDC requires minimal effort from the consumer and saves time since the consumer only needs to react to customized offers. PDC will continually find the best deal customized for the needs of the consumer, which provides maximum benefit to the consumer. Consumers no longer has to worry if they are getting the best deal because PDC is continually shopping for them, providing peace of mind. Consumers tend to feel that PDC is their advocate, leading to a high degree of loyalty.

Although not limited to commodity services, PDC works best in the market for commodity services for several reasons. Consumers buy commodity services on a recurring basis that matches the continual nature of PDC. Consumers do not want to shop every month for services due to the time and effort required. Although there may be many benefit factors that enter into a consumer's decision to select a particular good or service, such as goods and service quality or response time, a buy decision generally includes a consideration of price. No physical distribution process is required because there is no physical product to ship. Consumers view PDC as a trusted advocate rather than a store, allowing for multiple cross-selling opportunities.

PDC is primarily an Internet-based service for consumers for comparing prices on goods and services. In addition, PDC provides a component that monitors market offerings on an ongoing basis, and notifies consumers of additional opportunities with improved benefits when a better match is found between a market offering and a consumer's usage or lifestyle profile. The potential markets for PDC may be everything that a consumer writes a monthly check for. Examples of PDC applications include, but are not limited to, long distance telephone service, local telephone service, cell phone service, mortgage, home owners insurance, automobile insurance, life insurance, Internet service providers, electricity, gas, water, banking services, insurance services, groceries, etc. Other applications may include credit cards, entertainment services such as cable or satellite television, informational services such as traffic, security and neighborhood news, and airline tickets. PDC may also provide searches for tangible goods at a specific price. PDC provides the consumer with an ongoing offer-based searching service.

Table 1 illustrates some of the salient differences between a profile driven commerce model and a traditional e-commerce transaction model. The consumer generally has more benefits in a profile driven commerce model. The PDC model is optimized for recurring goods and services and offers high information content. It produces high consumer loyalty built on recurring transaction relationships. The PDC model offer extensive cross-marketing opportunities and requires little effort on the part of the consumer. It offers high consumer comfort and provides an advocate for the consumer. The revenue stream from the PDC model is recurring because it always offers the consumer the “best” match between market offerings and consumer lifestyle or usage profile.

TABLE 1

| | E-Commerce | Profile Driven |
|---|---|---|
| | Transaction | Commerce |
| | Model | Model |
| Optimal Market | Tangible Goods | Recurring Goods |
| | | and Services |
| Information/Choice | Medium | High |
| Best Consumer Price | Not Likely | Always |
| Revenue | Driven by Seller | Recurring |
| Consumer Loyalty | Low | High |
| Relationship | One-Time | Recurring |
| Cross-Marketing | Limited | Extensive |
| Consumer Perception | Store | Advocate |
| Consumer Effort | High; Proactive | Low; Respond |
| | Shopping | to Offers |
| Customer Comfort | Medium | High |
| Sellers Reward | Not Always | Rewarded if |
| | Rewarded | Competitive |
| Empowered | Seller Empowered | Consumer Empowered |

An embodiment of the present invention is directed towards a system and method for profile driven commerce whereby a user may log onto an Internet website and enter information regarding the consumer's lifestyle or usage profile. This information enables the system to build a customized user profile that is used by the system to compare with market offerings from various providers. The system then presents recommendations to the consumer that the consumer may accept or reject. If requested by the consumer, the system may contact a designated provider in order to switch from the present consumer provider to the designated provider. Furthermore, the system may periodically update the consumer's usage profile either by consumer-entered information or by extracting information from a provider's billing operation. If more benefit-effective offerings become available, the system notifies the consumer of these additional choices. The selection of provider may be based on a variety of consumer-selected benefits, including but not limited to highest quality, lowest cost, fastest response, consumer support services, and prompt delivery.

Using an embodiment of the present invention, consumers can quickly find the “best” offering for their specific needs, resulting in optimized benefits as well as saving time and money. Providers of goods and services also benefit by having direct access to customers, resulting in a better understanding of consumer needs.

A method for profile driven commerce having features of the present invention comprises receiving consumer goods and services usage profile and lifestyle information by a profile driven commerce system, storing the consumer usage profile and lifestyle information, calculating a consumer benefit for each of a plurality of market offerings using the consumer usage profile and lifestyle information, determining a multiplicity of market offerings having highest values of calculated consumer benefits, and displaying the multiplicity of highest benefit market offerings to a consumer. The method may further comprise displaying a detailed comparison of selected highest benefit market offerings to the consumer. The method may further comprise receiving a request from a consumer to switch to a selected displayed market offering for providing goods and services to the consumer, and notifying a provider of the selected market offering of the consumer request to switch to the selected market offering. The method may further comprise the step of not billing the consumer for switching to the selected market offering. The step of receiving consumer usage profile and lifestyle information may comprise receiving consumer usage profile and lifestyle information transmitted to the profile driven commerce system via the Internet. The step of receiving consumer usage profile and lifestyle information may comprise receiving a consumer's geographic location, receiving a monthly average bill amount for a provided goods or service, and receiving a selection of one of several predetermined profiles and lifestyles that most closely matches the consumer's usage habits of the provided goods and service. The step of receiving consumer usage profile and lifestyle information may comprise receiving a consumer's geographic location, receiving a monthly average bill amount for a provided goods and services, receiving a monthly average usage amount for the provided goods and services, receiving a selection of one of several predetermined profiles and lifestyles that most closely matches the consumer's usage habits of the provided goods and services, and receiving usage amounts for the provided goods and services based on daytime usage, nighttime usage, Saturday usage, and Sunday usage. The method may further comprise receiving usage amounts for the provided goods and services based on geographic usage. The method may further comprise receiving usage amounts for the provided goods and services based on intrastate usage, interstate usage, and international usage. The step of receiving consumer usage profile and lifestyle information may be selected from the group consisting of receiving consumer usage profile and lifestyle information from a billing service, receiving consumer usage profile and lifestyle information from a consumer, and receiving consumer usage profile and lifestyle information from a goods and services provider. The method may further comprise enabling the profile driven commerce system to periodically perform the steps of calculating a consumer benefit for each of a plurality of market offerings using the consumer usage profile and lifestyle information, determining a multiplicity of market offerings having highest values of calculated consumer benefits, and notifying a consumer of plans having higher values of calculated consumer benefits than previously calculated. The step of notifying may comprise sending an email communication to a consumer. The step of calculating a consumer benefit may comprise calculating a consumer monthly weighted average billing rate adjusted for a billing increment, calculating a total monthly consumer usage using the adjusted weighted average, calculating a total consumer benefit for a selected market offering and save results, and repeating the previous step until the benefits of all consumer plan have been calculated. The step of displaying the multiplicity of highest benefit market offerings may comprise displaying a name for each plan, displaying estimated monthly consumer bill for each plan, and displaying a quality rating for each plan. The method may further comprise receiving a request for enabling a consumer to create an account for receiving future notification of higher benefit market offerings. The method may further comprise receiving commissions by a profile driven commerce system provider from market offering providers. The method may further comprise enabling a profile driven commerce system provider to generate revenues by selling aggregate consumer usage profile and lifestyle information. The method may further comprise enabling market offering providers to tailor market offerings to specific groups of consumers based on aggregate consumer usage profile and lifestyle information. Each of the market offerings may comprise a bundle of market offerings for different goods and services. The type of market offering may be selected from the group consisting of local telephone service, long distance telephone service, international telephone service, internet access service, natural gas service, electric power service, water and sewer utility service, mortgage service, banking service, insurance service, groceries, entertainment service, information service, and airline reservation service. The method may further comprise receiving market offering information from goods and service providers. The benefit may be selected from the group consisting of lowest cost, highest quality, fastest response, consumer support services, and prompt delivery.

In an alternate embodiment of the invention, a method for profile driven commerce comprises receiving consumer goods and service usage profile and lifestyle information, matching the consumer goods and service usage profile and lifestyle information with a plurality of market offerings to determine a multiplicity of plans having highest consumer benefit, and displaying the multiplicity of highest benefit plans to a consumer. The receiving consumer goods and service usage profile and lifestyle information may include receiving goods and service usage time, goods and service usage benefits, and a consumer selected predetermined goods and service usage profile and lifestyle. The method may further comprise sending consumer requests for switching market offerings to goods and service providers and receiving market offering information from goods and service providers. The method may further comprise sending notification to consumers of higher benefit market offerings based on recent periodic recalculation of market offering information. Each market offering may comprise a bundle of market offerings for different goods and services.

In another embodiment of the invention, a method for profile driven commerce comprises entering consumer goods and service profile and lifestyle information into a profile driven commerce system, viewing a multiplicity of market offerings having highest calculated consumer benefit values, selecting a preferred market offering, and requesting a change in goods and service to the requested market offering. The method may further comprise selecting and viewing a detailed comparison of the multiplicity of market offerings. Entering consumer goods and service usage profile and lifestyle information may include entering goods and service usage time, goods and service usage costs, and a consumer selected predetermined goods and service usage profile and lifestyle. The method may further comprise receiving notification of higher benefit plans based on recent periodic recalculation of market offering information. Each market offering may comprise a bundle of market offerings for different goods and services.

In another embodiment of the invention, a system for profile driven commerce comprises an internet connection and web server for receiving consumer goods and service usage profile and lifestyle information and consumer selections, and for displaying information and sending notification to a consumer, a memory for storing consumer usage profile and lifestyle information, a computer for calculating benefit values for each of a plurality of market offerings using the consumer usage profile and lifestyle information and for determining a multiplicity of market offerings having highest values of calculated consumer benefits, and a computer means for displaying the multiplicity of highest benefit market offerings and a detailed comparison of selected highest benefit market offerings to the consumer. The system may further comprise communication means to send market offering switch requests from consumers to goods and service providers and to receive market offering information from the goods and service providers. The system may further comprise communication means for receiving consumer goods and service usage profile and lifestyle information from consumers, from billing services and from goods and service providers.

In another embodiment of the present invention, a method in a computer system for profile driven commerce comprises reading consumer profile and lifestyle information, determining consumer location, looking up geographic rates for current consumer market offering, looking up usage pattern and average usage of goods and service from user profile and lifestyle, calculating weighted average billing rate, adjusting weighted average for billing increment, calculating the total monthly usage using the adjusted weighted average, selecting a goods and service provider plan, determining the selected plan geographic rates, calculating the total consumer benefit value for the selected plan and saving the calculated value, repeating the previous three steps of selecting, determining and calculating for all plans, and sorting the plans by benefit and displaying the ten highest benefit value plans. The sorting step may comprise sorting the plans by quality rating and displaying the ten highest quality plans having the highest benefit value. Another embodiment of the present invention is a computer-readable medium containing instructions for controlling a computer system to carry out the preceding steps.

### BRIEF DESCRIPTION OF THE DRAWINGS

These and other features, aspects, and advantages of the present invention will become understood with regard to the following description, appended claims, and accompanying drawings where:

FIG. 1 shows a representation of a traditional e-commerce transaction business model;

FIG. 2 shows a representation of a PDC business model;

FIG. 3 shows a configuration of a PDC system;

FIG. 4 shows multiple ways for collecting consumer usage data;

FIG. 5 shows an Internet web page for starting a PDC analysis;

FIG. 6A shows an Internet web page for entering data to obtain a quick analysis;

FIG. 6B shows an Internet web page containing the results of a quick analysis;

FIG. 6C shows an Internet web page containing a side-by-side comparison of several selected plans resulting from a quick analysis;

FIG. 6D shows an Internet web page for creating an account and receiving notification of goods and service updates;

FIGS. 7A and 7B show Internet web pages for entering data to obtain a detailed analysis;

FIG. 7C shows an Internet web page containing the results of a detailed analysis;

FIG. 7D shows an Internet web page containing a side-by-side comparison of several plans resulting from a detailed analysis;

FIG. 8 shows a representative list of parameters for a telephone user profile;

FIG. 9 shows a representative list of parameters for a telephone service provider plan profile; and

FIG. 10 shows a flow diagram for a PDC system.

### DETAILED DESCRIPTION

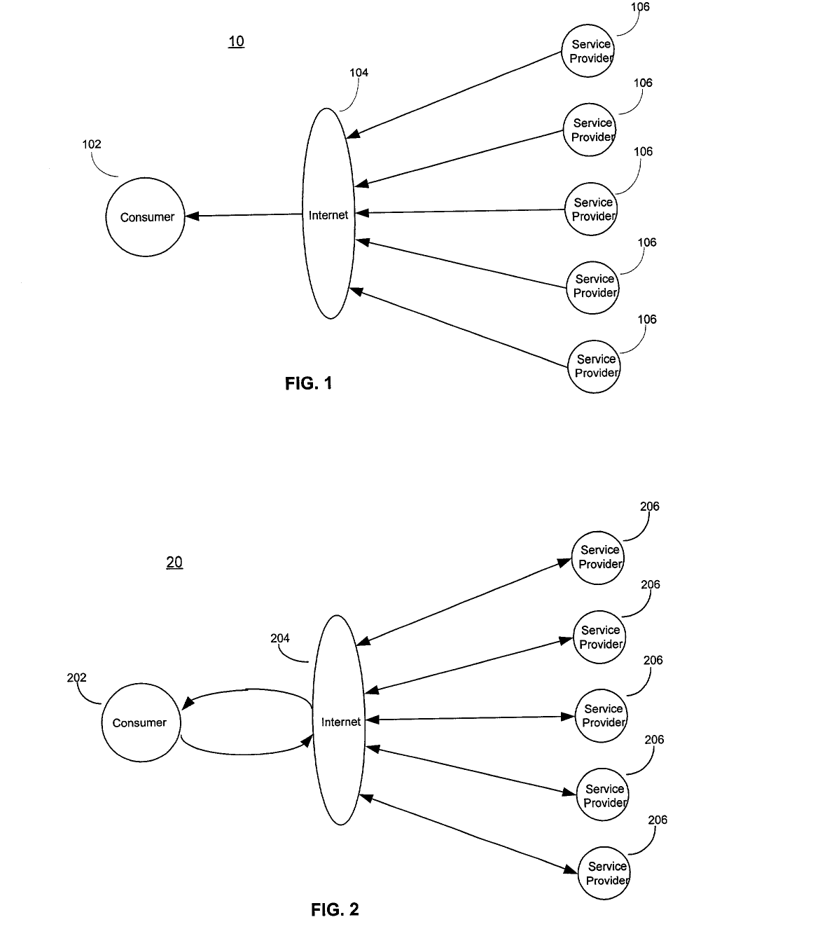

Turning now to FIG. 1, FIG. 1 shows a representation 10 of a traditional e-commerce transaction business model in use by commodity service providers 106. FIG. 1 depicts multiple goods and service providers 106 supplying information regarding their goods and services to a consolidated Internet website 104 which is available to a consumer 102. The Internet website 104 may also be supplied with information from a single agent or goods and service provider 106 to provide rate quotes to a consumer 102. Although a single goods and service provider website 104 may be convenient for consumers 102 and allow potential cost savings to providers 106, they do not provide comparative shopping opportunities and do not offer long term monitoring of rates. There are several websites 104 that utilize publicly available rate data to offer online consumer access to information. However, these websites afford only a limited number of plans, much of the information is out-of-date, there is no ability for the consumer 102 to determine projected monthly expenditures, there is no ability to switch the consumer's provider online, and there is no ongoing rate monitoring available. With these existing websites 104, the consumer 102 must still contact the provider 106 directly in order to complete a transaction, reducing the usefulness of the website 104 for the consumer 102. While this model provides some benefits to consumers and providers, it does not adequately exploit the advantages provided by the Internet.

Turning now to FIG. 2, FIG. 2 shows a representation 20 of a PDC business model in use by commodity goods and service providers 206. FIG. 2 depicts multiple goods and service providers 206 supplying information regarding their goods and services to a consolidated Internet website 204 which is available to a consumer 202. This model directly links consumers 202 and goods and service providers 206 via a website 204, allowing consumers 202 to compare goods and service provider sponsored plan information from a variety of goods and service providers 206 on an apples-to-apples basis, compare projected expenditures based on their specific calling patterns, select a goods and service provider 206 most suited to their needs and budget, and optionally affect the change to a new goods and service provider 206 online. Consumers 202 also have the option of having a profile driven commerce system monitor rates of goods and service providers 206 and consumer usage, and notify the consumer 202 when their criteria are met for switching plans again, usually to a lower-priced plan. This model provides consumers 202 with the benefit of the market offering they need and goods and service providers 206 with the customers they are targeting with their plans. This model is especially effective when the goods and services provided have low switching costs for consumers 202. In a typical PDC business model, a PDC business generates revenue through commissions paid by the goods and service providers.

Turning now to FIG. 3, FIG. 3 shows a configuration 30 of a PDC system. Using a consumer's computer 302, a consumer communicates with a PDC web server 306 via the Internet 304. The PDC web server 306 hosts the PDC web pages that enable a consumer to enter consumer usage profile and lifestyle information and obtain results and a side-by-side comparison of selected goods and service provider plans. The PDC web server 306 communicates with a PDC application server 308 to provide consumer usage profile and lifestyle information and receive information regarding selected goods and service provider plans. The PDC application server 308 stores consumer profile and lifestyle information in a PDC consumer profile and lifestyle database 310. The PDC application server 308 also communicated with goods and service providers 314 to obtain information on the various plans offered by the goods and service providers 314. Most goods and service providers 314 may make plan pricing and plan information directly available to the PDC application server. The PDC application server 308 stores this information about the goods and service provider plans in a PDC provider profile and lifestyle database 312. Search algorithms within the PDC application server 308 compare consumer usage profile and lifestyle data in the PDC consumer profile and lifestyle database 310 with the goods and service provider plan information stored in the PDC provider profile and lifestyle database 312 to locate the lowest priced plan suitable for a particular consumer profile and lifestyle. The information regarding specific individuals is not shared with outside organizations, although the aggregate information and group switching behavior may be made available to specific goods and service providers. Since the goods and service providers pay a fee to the PDC provider, the goods and service offered by the PDC provider is free to the consumer. The PDC application server 308 has the capability to request a switch of a consumer goods and service provider, based on a request by the consumer. The PDC application server 308 also has the capability to provide proactive searching activity at a consumer's request in order to find a suitable goods and service provider plan with the highest benefit.

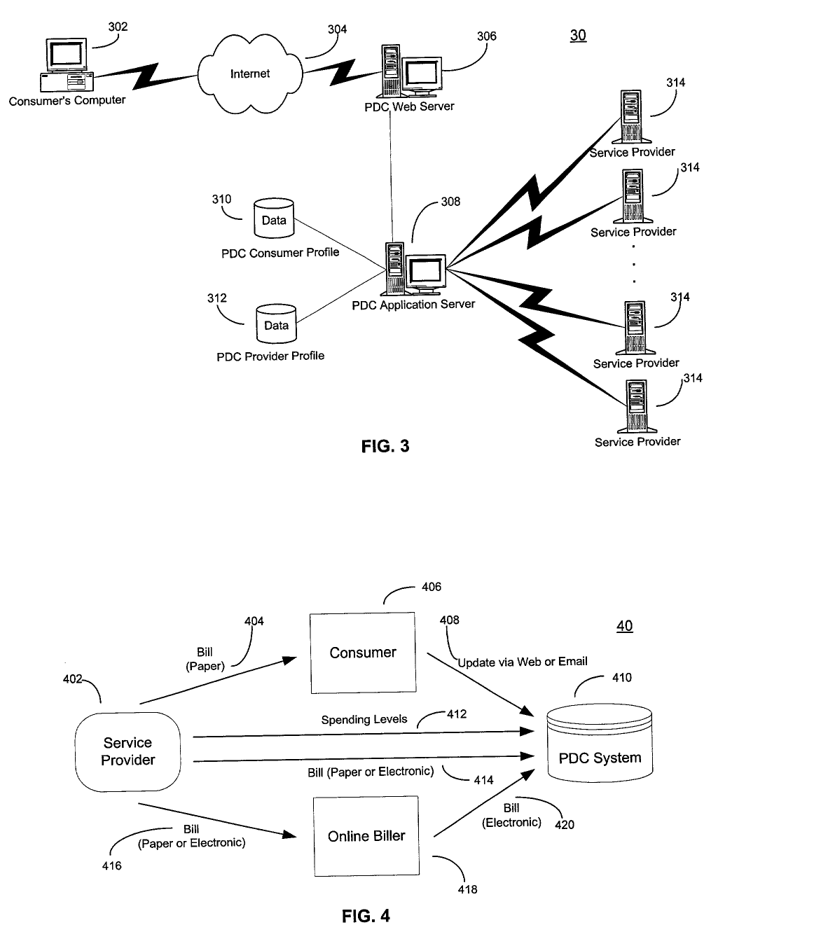

Turning now to FIG. 4, FIG. 4 shows multiple ways for collecting consumer usage data 40. A goods and service provider 402 generates a bill for the goods and services it provides to a consumer 406. The goods and service provider 402 may send a paper bill 404 to the consumer 406, usually by the U.S. Postal Service. The consumer 406 may provide its usage profile and lifestyle information from the bill 404 to the PDC system 410 by either the PDC website or email 408. The goods and service provider 402 may also transmit consumer spending levels 412 and electronic or paper billing information 414 directly to the PDC system 410. Alternatively, the goods and service provider 402 may send a paper or electronic bill 416 to an online billing service 418. In addition to billing the consumer online, the online billing service transmits electronic consumer billing information 420 to the PDC system 410. The PDC system 410 uses the billing information collected from the various sources to update the consumer usage profile and lifestyle information and uses the information to match the consumer usage profile and lifestyle to a suitable goods and service provider plan.

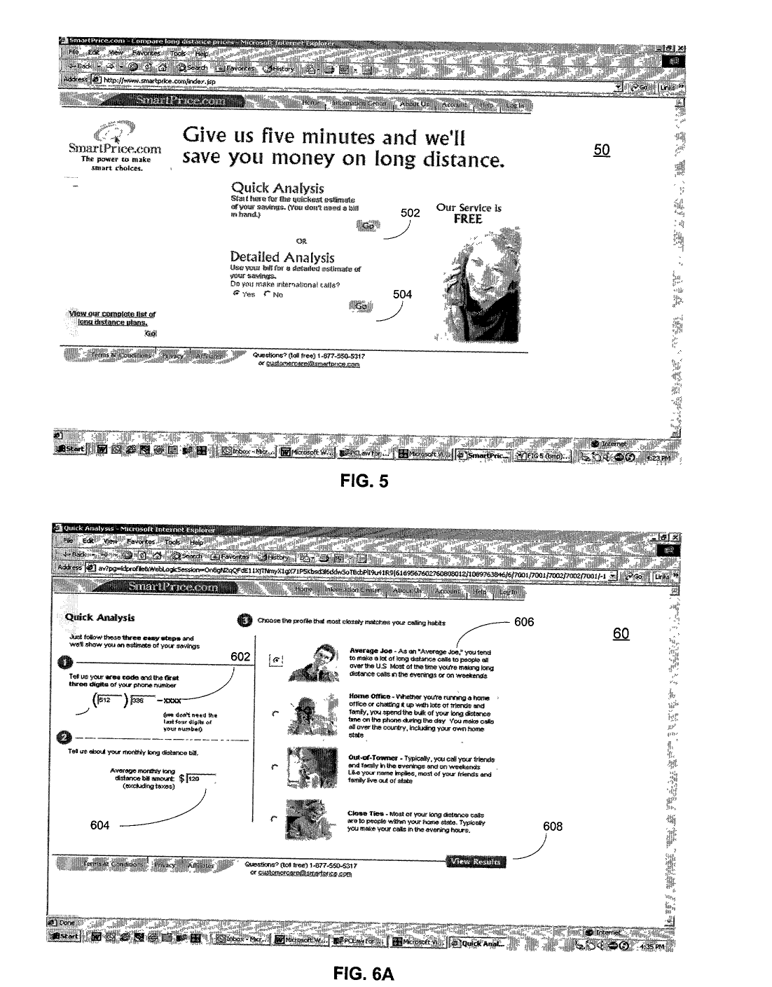

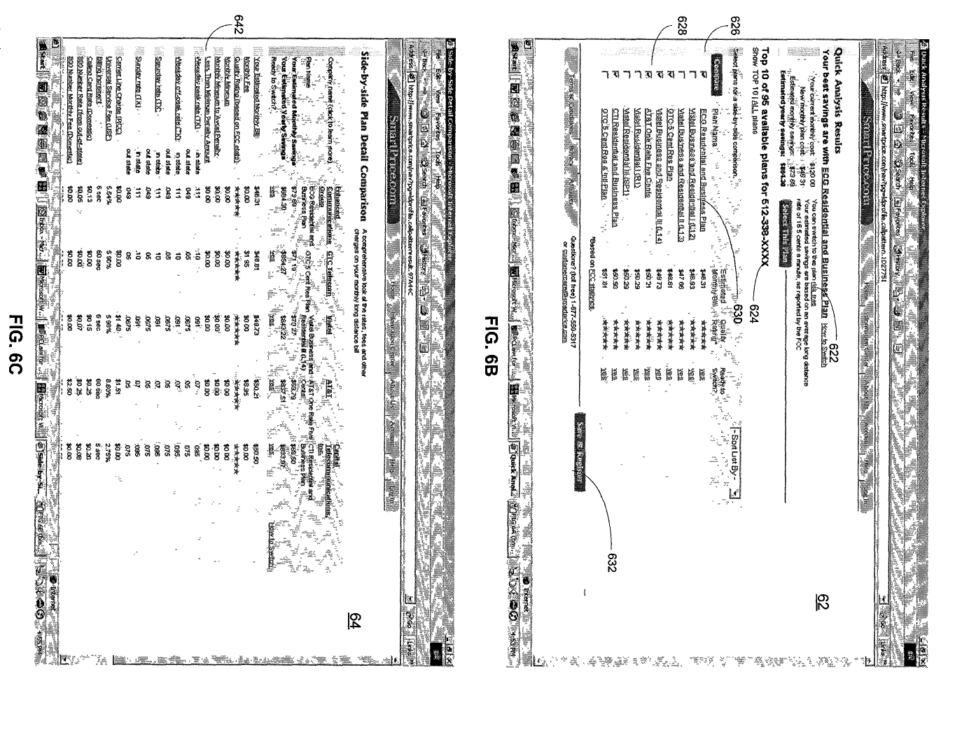

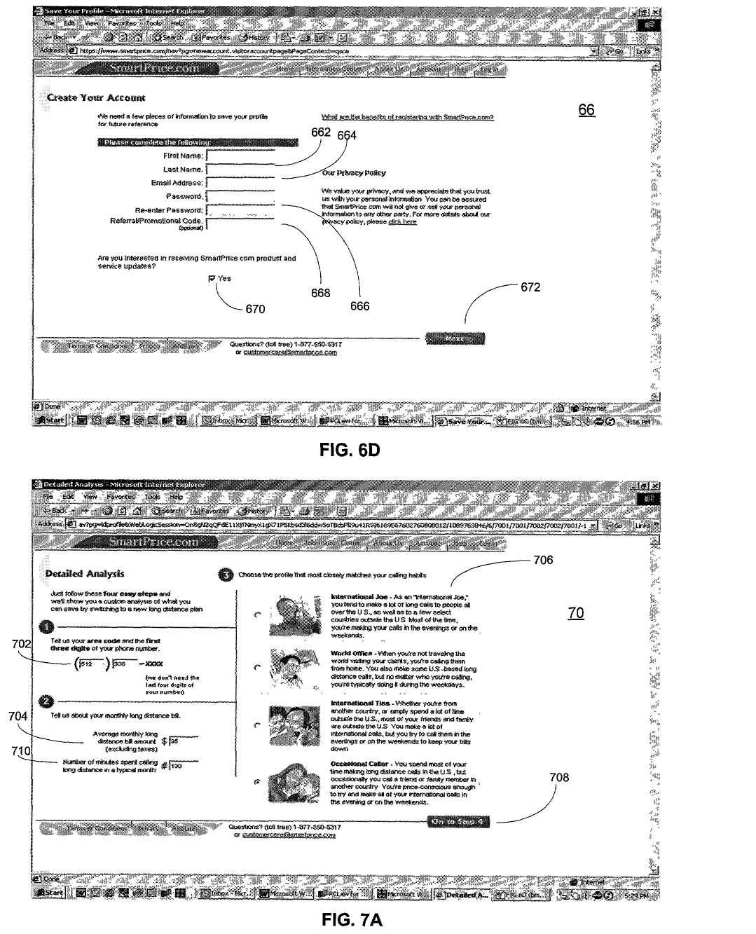

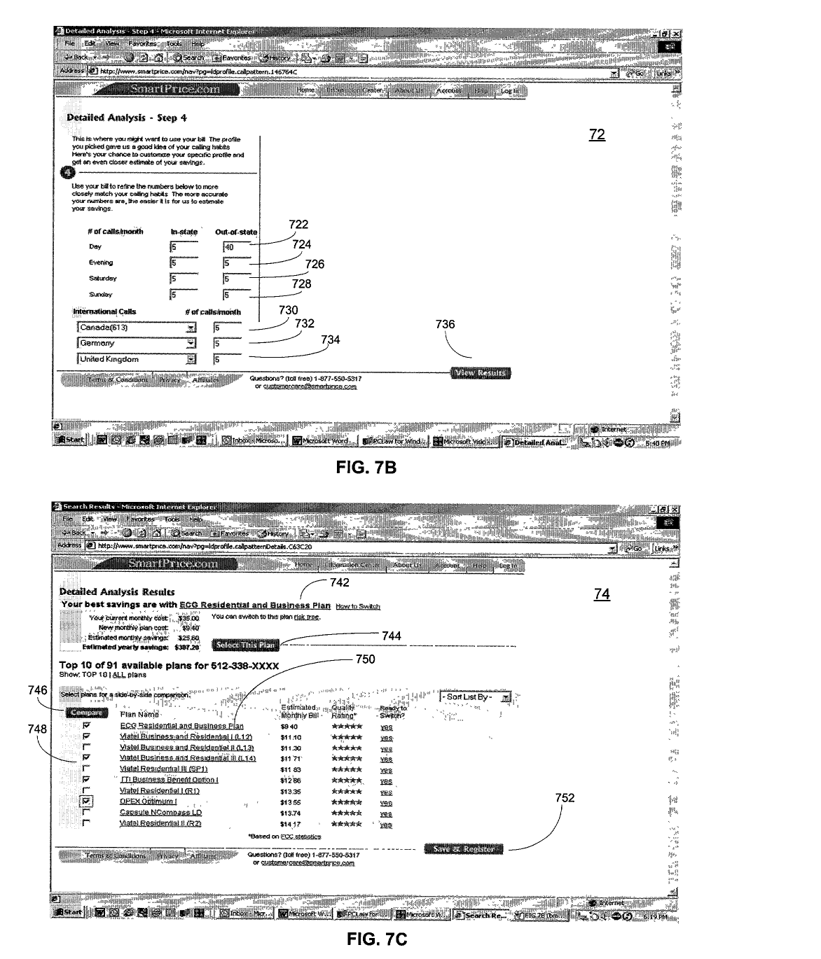

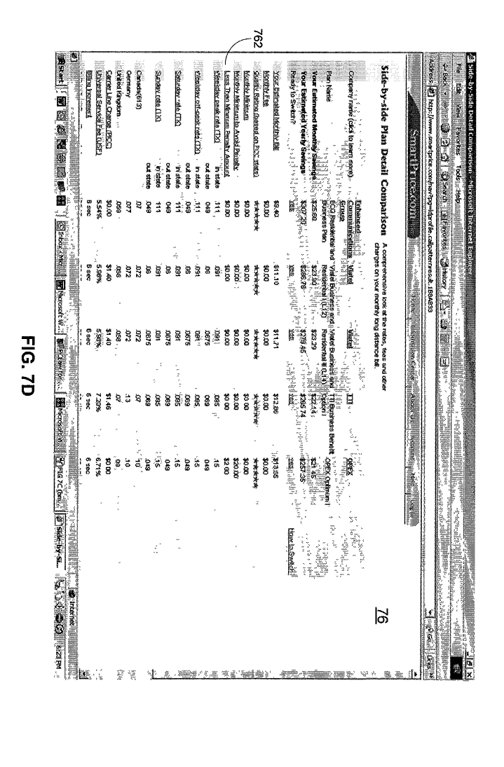

Turning now to FIG. 5, FIG. 5 shows an Internet web page 50 for starting a profile driven commerce analysis for long distance telephone prices. Although the following examples discussed in relation to FIG. 5, FIG. 6 and FIG. 7 illustrate the use of PDC transactions for long distance telephone service, these example could apply equally well to other commodity goods and service transactions. Consumers who enter the website must provide specific telephone call profile information. The time-oriented consumer can fill in a minimum of information, such as phone number, amount spent on long distance telephone calls last month, and which one of several standard profiles and lifestyles the consumer fits into. Consumers who desire a more accurate result may enter additional information, such as number of minutes spent calling long distance, the number of calls per month for in-state and out-of-state calls broken down by day, evening, Saturday and Sunday calls, and the number of international calls that were made to designated foreign countries. To obtain a fast estimate of possible savings in long distance telephone plans, a consumer clicks the Quick Analysis Go button 502, which causes the screen shot shown in FIG. 6A to be displayed to the consumer. To obtain a detailed estimate of possible savings in long distance telephone plans, the consumer checks the Yes or No circle in answer to the question concerning international calls and clicks the Detailed Analysis Go button 504 which causes the screen shot shown in FIG. 7A to be displayed to the consumer.

Turning now to FIG. 6A, FIG. 6A shows an Internet web page 60 for entering data to obtain a quick analysis. This page is displayed after a consumer selects the Quick Analysis Go button shown in FIG. 5. To obtain a quick analysis, the consumer must first enter an area code and the first three digits of a phone number 602. Second, the consumer must then enter an amount spent for an average monthly long distance bill 604. Third, the consumer must select one of several predetermined profile and lifestyles that most closely match the consumer's calling habits 606. These predetermined profiles and lifestyles use standard U.S. calling pattern assumptions to fill in gaps in the consumer usage profile and lifestyle information. And fourth, the consumer must then select the View Results button 608, causing the screen shot shown in FIG. 6B to be displayed.

Turning now to FIG. 6B, FIG. 6B shows an Internet web page 62 containing the results of a quick analysis based on the consumer entered data in FIG. 6A. The plan 622 that the PDC system found to provide the best savings by matching consumer usage profile and lifestyle information to goods and service provider plan profile data is shown at the top of the web page 62. The top 10 results 630 of the match on the plan database sorted by the lowest overall monthly bill is shown on the web page 62. If the consumer wishes to switch to this recommended plan, a Select This Plan button 624 is clicked. If the consumer wishes to compare selected plans in greater detail, boxes 628 adjoining the selected plans are selected and a Compare button 626 is clicked, causing the screen shot shown in FIG. 6C to be displayed. If the consumer wishes to register and receive notification of goods and service updates, a Save & Register button 632 is selected, causing the screen shot shown in FIG. 6D to be displayed.

Turning now to FIG. 6C, FIG. 6C shows an Internet web page 64 containing a side-by-side comparison of several selected plans that resulted from the consumer selecting the Compare button in FIG. 6B. The side-by-side comparison includes estimated savings, quality rating, various rates and fees 642 associated with each of the selected plans.

Turning now to FIG. 6D, FIG. 6D shows an Internet web page 66 for creating an account and receiving notification of goods and service updates that resulted from the consumer selecting the Save & Register button in FIG. 6B. Registration requires the consumer's name 662, email address 664, password 666 and promotional code 668. If the consumer is interested in receiving notification of goods and service updates, a Yes box 670 is selected and a Next button 672 is clicked, which causes a confirmation page to be displayed.

Turning now to FIG. 7A, FIG. 7A shows Internet web page 70, for entering data to obtain a detailed analysis. The page shown in FIG. 70 is displayed after a consumer selects the Detailed Analysis Go button shown in FIG. 5. To obtain a detailed analysis, the consumer must first enter an area code and the first three digits of a phone number 702. Second, the consumer must then enter an amount spent for an average monthly long distance bill 704. Third, the consumer must enter the number of minutes spent calling long distance in a typical month 710. Fourth, the consumer must select one of several predetermined profiles and lifestyles that most closely match the consumer's calling habits 706. These predetermined profiles and lifestyles use standard U.S. calling pattern assumptions to fill in gaps in the consumer usage profile and lifestyle information. And fifth, the consumer must then select the On to Step 4 button 708, causing the screen shot shown in FIG. 7B to be displayed.

Turning now to FIG. 7B, FIG. 7B shows Internet web page 72, for entering additional data to obtain a detailed analysis. The page shown in FIG. 72 is displayed after a consumer selects the On to Step 4 button shown in FIG. 7A. Using the consumer's bill, the consumer enters usage profile and lifestyle information regarding the number of in-state and out-of-state telephone calls per month made during the day 722, during the evening 724, on Saturday 726 and on Sunday 728. In addition, the consumer enters the number of international calls per month made to foreign countries 730, 732, 734. The consumer must then select the View Results button 736, causing the screen shot shown in FIG. 7C to be displayed.

Turning now to FIG. 7C, FIG. 7C shows an Internet web page containing the results of a detailed analysis based on the consumer entered data in FIG. 7A and FIG. 7B. The plan 742 that the PDC system found to provide the best savings by matching consumer usage profile and lifestyle information to goods and service provider plan profile data is shown at the top of the web page 74. The top 10 results 750 of the match on the plan database sorted by the lowest overall monthly bill is shown on the web page 74. If the consumer wishes to switch to this recommended plan, a Select This Plan button 744 is clicked. If the consumer wishes to compare selected plans in greater detail, boxes 748 adjoining the selected plans are selected and a Compare button 746 is clicked, causing the screen shot shown in FIG. 7D to be displayed. If the consumer wishes to register and receive notification of goods and service updates, a Save & Register button 752 is selected, causing the screen shot described and shown in FIG. 6D to be displayed.

Turning now to FIG. 7D, FIG. 7D shows an Internet web page 76 containing a side-by-side comparison of several selected plans that resulted from the consumer selecting the Compare button in FIG. 7C. The side-by-side comparison includes estimated savings, quality rating, various rates and fees 762 associated with each of the selected plans.

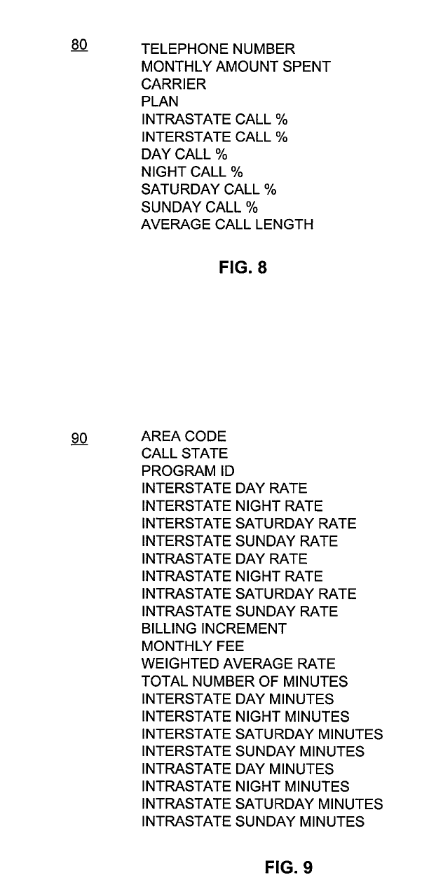

Turning now to FIG. 8, FIG. 8 shows a representative list of parameters 80 for a telephone user profile and lifestyle. FIG. 8 defines a template that is used to characterize the variable parameters 802 that comprise a consumer telephone usage profile and lifestyle.

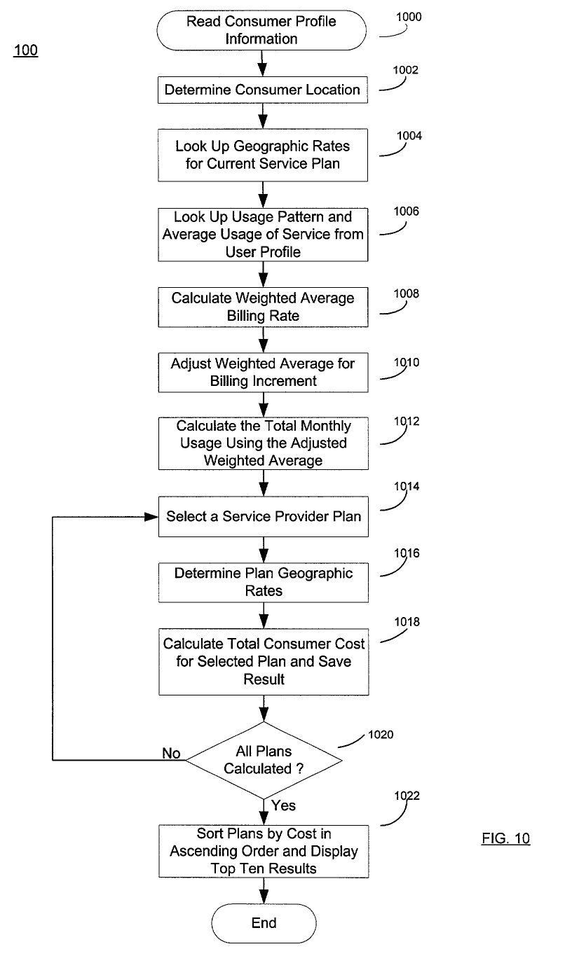

Turning now to FIG. 9, FIG. 9 shows a representative list of parameters 90 for a telephone service provider plan profile. FIG. 9 defines a template that is used to characterize the variable parameters 902 that comprise a telephone market offering profile.

Turning now to FIG. 10, FIG. 10 shows a flow diagram 100 for a PDC system. This process 100 is executed whenever a user logs onto the PDC website, enters usage profile and lifestyle information and requests an analysis results. This process 100 is also executed periodically to determine whether a consumer continues to have the most benefit-effective plan for the consumer's goods and service usage profile and lifestyle. The first steps in the process are to read the consumer profile and lifestyle information 1000 and to determine the consumer's geographic location 1002. The PDC system then determines the geographic rates of the consumer's current market offering 1004. The consumer's goods and service usage pattern and average usage of goods and service are extracted from the consumer usage profile and lifestyle 1006, a weighted average billing rate is calculated 1008, the weighted average billing rate is adjusted for a billing increment 1010, and the total monthly usage is calculated using the weighted average 1012. A first of many telephone market offerings are now applied to the consumer usage profile and lifestyle information to determine an appropriate match of a market offering to a consumer usage profile and lifestyle. This sub-process comprises selecting a goods and service provider plan 1014, determine the plan geographic rates 1016, and calculating the total consumer benefit value for the selected plan while saving the result 1018. This sub-process is repeated until the consumer's benefit for all market offerings have been calculated and saved 1020. The plans are then sorted by benefit in ascending order and the top ten results are displayed for consideration by the consumer 1022. The plans may also be sorted by quality rating and highest benefit.

Although the present invention has been described in detail with reference to certain preferred embodiments, it should be apparent that modifications and adaptations to those embodiments may occur to persons skilled in the art without departing from the spirit and scope of the present invention as set forth in the following claims.

What is claimed is:

1. A method for profile driven commerce, comprising:
receiving consumer goods and service usage profile and lifestyle information by a profile driven commerce system;
storing the consumer usage profile and lifestyle information;
calculating a consumer benefit value for each of a plurality of market offerings using the consumer usage profile and lifestyle information;
determining a multiplicity of market offerings having highest values of calculated consumer benefits; and
displaying the multiplicity of highest benefit market offerings to a consumer.

2. The method of claim 1, further comprising displaying a detailed comparison of selected highest benefit market offerings to the consumer.

3. The method of claim 1, further comprising:
receiving a request from a consumer to switch to a selected displayed market offering for providing goods and service to the consumer; and
notifying a provider of the selected market offering of the consumer request to switch to the selected market offering.

4. The method of claim 3, further comprising the step of not billing the consumer for switching to the selected market offering.

5. The method of claim 1, wherein the step of receiving consumer usage profile and lifestyle information comprises receiving consumer usage profile and lifestyle information transmitted to the profile driven commerce system via the Internet.

6. The method of claim 1, wherein the step of receiving consumer usage profile and lifestyle information is selected from the group consisting of receiving consumer usage profile and lifestyle information from a billing service, receiving consumer usage profile and lifestyle information from a consumer, and receiving consumer usage profile and lifestyle information from a goods and service provider.

7. The method of claim 1, further comprising enabling the profile driven commerce system to periodically perform the steps of:
calculating a consumer benefit for each of a plurality of market offerings using the consumer usage profile and lifestyle information;
determining a multiplicity of market offerings having highest values of calculated consumer benefits; and
notifying a consumer of plans having higher values of calculated consumer benefits than previously calculated.

8. The method of claim 7, wherein the step of notifying comprises sending an email communication to a consumer.

9. The method of claim 1, wherein the step of calculating a consumer benefit comprises:
calculating a consumer monthly weighted average billing rate adjusted for a billing increment;
calculating a total monthly consumer usage using the adjusted weighted average;
calculating a total consumer benefit for a selected market offering and save results; and
repeating the previous step until the benefits of all consumer plan have been calculated.

10. The method of claim 1, further comprising receiving a request for enabling a consumer to create an account for receiving future notification of higher benefit market offerings.

11. The method of claim 1, further comprising receiving commissions by a profile driven commerce system provider from market offering providers.

12. The method of claim 1, further comprising enabling a profile driven commerce system provider to generate revenues by selling aggregate consumer usage profile and lifestyle information.

13. The method of claim 1, further comprising enabling market offering providers to tailor market offerings to specific groups of consumers based on aggregate consumer usage profile and lifestyle information.

14. The method of claim 1, wherein each of the market offerings comprises a bundle of market offerings for different goods and services.

15. The method of claim 1, wherein the type of market offering is selected from the group consisting of local telephone service, long distance telephone service, international telephone service, internet access service, natural gas service, electric power service, water and sewer utility service, mortgage service, banking service, insurance service, groceries, entertainment service, information service, and airline reservation service.

16. The method of claim 1, further comprising receiving market offering information from goods and service providers.

17. The method of claim 1, wherein the benefit is selected from the group consisting of lowest cost, highest quality, fastest response, consumer support services, and prompt delivery.

18. A method for profile driven commerce, comprising:
receiving consumer goods and service usage profile and lifestyle information;
matching the consumer goods and service usage profile and lifestyle information with a plurality of market offerings to determine a multiplicity of plans having highest consumer benefit values; and
displaying the multiplicity of highest benefit plans to a consumer.

19. The method of claim 18, further comprising sending consumer requests for switching market offerings to goods and service providers and receiving market offering information from goods and service providers.

20. The method of claim 18, further comprising sending notification to consumers of higher benefit market offerings based on recent periodic recalculation of market offering information.

21. The method of claim 18, wherein each market offering comprises a bundle of market offerings for different goods and services.

22. A system for profile driven commerce, comprising:
an internet connection and web server for receiving consumer goods and service usage profile and lifestyle information and consumer selections, and for displaying information and sending notification to a consumer;
a memory for storing consumer usage profile and lifestyle information;
a computer for calculating benefit values for each of a plurality of market offerings using the consumer usage profile and lifestyle information and for determining a multiplicity of market offerings having highest values of calculated consumer benefits; and
a computer means for displaying the multiplicity of highest benefit market offerings and a detailed comparison of selected highest benefit market offerings to the consumer.

23. The system of claim 22, further comprising communication means to send market offering switch requests from consumers to goods and service providers and to receive market offering information from the goods and service providers.

24. The system of claim 22, further comprising communication means for receiving consumer goods and service usage profile and lifestyle information from consumers, from billing services and from goods and service providers.

25. A method in a computer system for profile driven commerce, comprising:
reading consumer profile and lifestyle information;
determining consumer location;
looking up geographic rates for current consumer market offering;
looking up usage pattern and average usage of goods and service from user profile and lifestyle;
calculating weighted average billing rate;
adjusting weighted average for billing increment;
calculating the total monthly usage using the adjusted weighted average;
selecting a goods and service provider plan;
determining the selected plan geographic rates;
calculating a total consumer benefit value for the selected plan and saving the calculated value;
repeating the previous three steps of selecting, determining and calculating for all plans; and
sorting the plans by benefit and displaying the ten highest benefit value plans.

26. The method of claim 25, wherein the sorting step comprises sorting the plans by quality rating and displaying the ten highest quality plans having the highest benefit value.

27. A computer-readable medium containing instructions for controlling a computer system to carry out the steps of claim 25.
